(19) United States
(12) Patent Application Publication
(10) Pub. No.: US 2019/0256720 A1
(43) Pub. Date: Aug. 22, 2019

(54) ANTI-FOULING, MULTI-LAYER COATED SAPPHIRE ARTICLES

(71) Applicant: PPG INDUSTRIES OHIO, INC., CLEVELAND, OH (US)

(72) Inventors: SONGWEI LU, WEXFORD, PA (US); JIPING SHAO, SEWICKLEY, PA (US)

(73) Assignee: PPG INDUSTRIES OHIO, INC., CLEVELAND, OH (US)

(21) Appl. No.: 15/902,656

(22) Filed: Feb. 22, 2018

(51) Int. Cl. C09D 5/16; C09D 183/04; C09D 183/02; C08L 83/08; C09J 183/04; C01F 7/02; C07F 7/08

(52) U.S. Cl. CPC C09D 5/1637; C09D 183/04; C09D 183/02; C01P 2002/30; C09J 183/04; C01F 7/02; C07F 7/085; C08L 83/08

(57) ABSTRACT

Coated articles demonstrating anti-fouling properties are provided, comprising:
(a) a substrate comprising sapphire;
(b) an adhesion promoting layer applied to the substrate; and
(c) a top layer comprising at least an anti-fouling coating applied to the adhesion promoting layer. The adhesion promoting layer is formed from a curable sol-gel composition and has a dry film thickness less than 1000 nm after curing. The present invention also provides a method of forming a coated article comprising:
(a) applying a curable film-forming sol-gel composition on a sapphire substrate, to form a coated substrate with a sol-gel adhesion promoting layer having a dry film thickness less than 1000 nm after curing;
(b) subjecting the coated substrate to a temperature of at least 500° C. to effect cure of the sol-gel composition; and
(c) applying at least an anti-fouling coating on the adhesion promoting layer to form a multi-layer, coated article.

### FIELD OF THE INVENTION

The present invention relates to coated sapphire articles, such as touch screen and non-touch screen displays, which demonstrate anti-fouling properties.

### BACKGROUND OF THE INVENTION

Information displays such as touch screen displays are integral components of interactive electronic devices. Because many of these devices are portable or even hand-held, the display screens and camera lens covers on integral cameras are subject to fouling or smudging by oils, dirt, and other contaminants that adversely affect their appearance and performance.

Numerous anti-fouling coatings for optical articles such as screens and lenses have been developed, but often have poor adhesion to sapphire, a preferred substrate for touch screen displays and camera lens covers because of its superior optical properties and hardness.

It would be desirable to provide multi-layer coatings on a sapphire substrate that offer superior anti-fouling properties with adequate adhesion to the substrate to prevent coating adhesion failure.

### SUMMARY OF THE INVENTION

Coated articles demonstrating anti-fouling properties are provided, such as a coated article comprising:

(a) a substrate comprising sapphire;

(b) an adhesion promoting layer applied to at least one surface of the substrate; wherein the adhesion promoting layer is formed from a curable sol-gel composition and wherein the adhesion promoting layer has a dry film thickness of less than 1000 nm after curing; and

(c) a top layer applied to at least one surface of the adhesion promoting layer; wherein the top layer comprises at least an anti-fouling coating.

The present invention also provides a method of forming a coated article comprising:

(a) applying a curable film-forming sol-gel composition on at least one surface of a sapphire substrate, to form a coated substrate with a sol-gel adhesion promoting layer, wherein the sol-gel adhesion promoting layer has a dry film thickness of less than 1000 nm after curing;

(b) subjecting the coated substrate to a temperature of at least 500° C. for a time sufficient to effect cure of the sol-gel adhesion promoting layer; and

(c) applying at least one topcoat composition on at least one surface of the adhesion promoting layer; wherein the topcoat composition comprises an anti-fouling coating, to form a multi-layer, coated article.

### DETAILED DESCRIPTION OF THE INVENTION

Other than in any operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used in this specification and the appended claims, the articles “a,” “an,” and “the” include plural referents unless expressly and unequivocally limited to one referent.

The various aspects and examples of the present invention as presented herein are each understood to be non-limiting with respect to the scope of the invention.

The substrate (a) used in the coated articles of the present invention comprises sapphire, and is suitable for use as an optical substrate such as a touch screen, a non-touch screen, a camera lens or protective lens cover. Optical substrates may include components of electronic and other devices that are hand held, as well as architectural glazings and devices in vehicles. The term “optical substrate” means that the specified substrate exhibits a light transmission value (transmits incident light) of at least 40 percent, such as at least 50 percent, or at least 70 percent, or at least 85 percent; and exhibits a haze value of less than 5 percent, e.g., less than 1 percent or less than 0.5 percent, when the haze value is measured at 550 nanometers by, for example, by Color i7 spectrophotometer from X-Rite, Inc. Optical substrates include, but are not limited to, optical articles such as ophthalmic and other lenses, windows, mirrors, active or passive liquid crystal cell elements or devices, and display elements such as screens; for example, touch screens on devices including cell phones, tablets, GPS, voting machines, POS (Point-Of-Sale), or computer screens; display sheets such as those in a picture frame; monitors, wearable displays such as a watch crystal, or security elements.

The term “transparent”, as used for example in connection with a substrate, film, material and/or coating, means that the indicated substrate, coating, film and/or material has the property of transmitting light without appreciable scattering so that objects lying beyond are entirely visible with visible light transmittance higher than 70%, often higher than 80%, and most often higher than 90%.

Synthetic sapphire, also known as “sapphire glass”, is particularly suitable as a substrate for optical articles because it demonstrates a very wide optical transmission band, transparent to wavelengths of light between 150 nm (UV) and 5500 nm (IR) (the visible light spectrum ranges from about 380 nm to 750 nm). Sapphire is also highly resistant to scratching and abrasion due to its very high hardness (“9” on the Mohs scale of mineral hardness). Sapphire additionally exhibits an extremely high melting temperature (2030° C.).

The substrate typically has at least one flat surface, and often has two opposing surfaces. Either one or both surfaces may be coated with the coatings.

The coated article of the present invention further comprises an adhesion promoting layer (b) applied to at least one surface of the substrate (a). By “adhesion promoting” is meant that the layer improves adhesion between an underlying coating or substrate and an overlying coating, both adjacent to the adhesion promoting layer, compared to adhesion between the underlying coating or substrate and overlying coating without the intervening adhesion promoting layer. Such adhesion may be measured using a test such as the “Steel Wool Wear Durability Test” described in the Examples below.

The adhesion promoting layer may be formed from a curable sol-gel composition comprising: (i) tetraalkoxysilane; (ii) a mineral acid; (iii) water; and (iv) an organic solvent. By “curable” is meant that the indicated composition is polymerizable or cross linkable through functional groups, e.g., by means that include, but are not limited to, thermal (including ambient cure), catalytic, electron beam, chemical free-radical initiation, and/or photoinitiation such as by exposure to ultraviolet light or other actinic radiation. By ambient conditions is meant that the coating undergoes a thermosetting reaction without the aid of heat or other energy, for example, without baking in an oven, use of forced air, or the like. Usually ambient temperature ranges from 60 to 90° F. (15.6 to 32.2° C.), such as a typical room temperature, 72° F. (22.2° C.).

Because of the sol-gel nature of the composition, the tetraalkoxysilanes (i) are hydrolyzed and they are usually partially condensed prior to curing the sol-gel composition. The tetraalkoxysilane in the sol-gel layer typically comprises tetramethoxysilane and/or tetraethoxysilane. The tetraalkoxysilane is typically present in the sol-gel composition in an amount of at least 1 percent by weight and less than 7 percent by weight, often less than 6 percent by weight, more often less than 5.5 percent by weight, based on the total weight of the acidic sol-gel composition.

The sol-gel composition further comprises (ii) a mineral acid. Suitable mineral acids include sulfuric acid, nitric acid, hydrochloric acid, and the like. Nitric acid is most often used. The mineral acid is typically present in an amount such that the weight ratio of mineral acid to silane is greater than 0.01, often greater than 0.04, more often greater than 0.08, most often greater than 0.1.

In addition to water (iii), the sol-gel composition comprises (iv) an organic solvent such as one or more polar organic solvents, including ethers such as cyclic ethers, glycol ethers, alcohols having 1 to 6 carbon atoms, such as methanol, ethanol, n-propanol, isopropanol, n-butanol, and the like. Glycol ethers such as propylene glycol methyl ether, propylene glycol methyl ether acetate, dipropylene glycol monomethyl ether, and/or diethylene glycol monobutyl ether are commonly used. Note that the phrase “and/or” when used in a list is meant to encompass alternative embodiments including each individual component in the list as well as any combination of components. For example, the list “A, B, and/or C” is meant to encompass seven separate embodiments that include A, or B, or C, or A+B, or A+C, or B+C, or A+B+C.

The water (iii) is typically present in the sol-gel composition in an amount of 0.1 to 35.0 percent by weight, based on the total weight of the sol-gel composition, and the organic solvent (iv) is typically present in the sol-gel composition in an amount of 60 to 98 percent by weight, based on the total weight of the sol-gel composition. This allows for a total solids content of at least 0.1 percent by weight, or at least 0.5 percent by weight, or at least 2.0 percent by weight; and a total solids content of at most 35 percent by weight, or at most 20 percent by weight, or at most 10 percent by weight. For example, the sol-gel composition typically has a solids content of 0.1 to 10 percent by weight, often 0.5 to 10 percent by weight, more often 1 to 8 percent by weight, usually less than 7 percent by weight or less than 5 percent by weight, based on the total weight of the sol-gel composition.

In certain examples of the present invention, the sol-gel composition additionally comprises (v) inorganic oxide nanoparticles. The nanoparticles can comprise a single inorganic oxide such as silica in colloidal, fumed, or amorphous form, alumina or colloidal alumina, titanium dioxide, cesium oxide, yttrium oxide, colloidal yttria, zirconia, e.g., colloidal or amorphous zirconia, zinc oxide, and mixtures of any of the foregoing; or an inorganic oxide of one type upon which is deposited an inorganic oxide of another type. Particle size may be determined from among the numerous techniques known in the art, such as the method described below. The particle size may be measured with a Malvern Zetasizer 3000HS, which is a high performance two angle particle size analyzer for the enhanced detection of aggregates and measurement of small or dilute samples, and samples at very low or high concentration using dynamic light scattering. Typical applications of dynamic light scattering are the characterization of particles, emulsions or molecules, which have been dispersed or dissolved in a liquid. The Brownian motion of particles or molecules in suspension causes laser light to be scattered at different intensities. Analysis of these intensity fluctuations yields the velocity of the Brownian motion and hence the particle size using the Stokes-Einstein relationship. The reported particle sizes for all examples are the Z average mean value which is less than 50 nm. When used, the particles are typically present in the sol-gel composition in an amount of 0.05 to 2.0 percent by weight, based on the total solids weight of the sol-gel composition. An example of a suitable adhesion promoting coating for use as the adhesion promoting layer (b) is SilicAR™ Anti-Reflection LR800 commercially available from Industrial Science & Technology Network, Inc., 1200 Corporate Blvd., STE 10C, Lancaster, Pa. 17601, USA

In other examples of the present invention, the curable sol-gel composition comprises (i) a zirconium alkoxide; (ii) an yttrium salt; (iii) a mineral acid such as any of those disclosed above; (iv) water; and (v) an organic solvent such as any of those noted above. Suitable zirconium alkoxides include zirconium(IV) propoxide and zirconium (IV) tert-butoxide. The zirconium alkoxide is typically present in an amount of at least 0.1 percent by weight, or at least 0.5 percent by weight, or at least 2.0 percent by weight; and at most 35 percent by weight, or at most 20 percent by weight, or at most 10 percent by weight.

Suitable yttrium salts include salts of organic acids such as yttrium acetate, and ytterbium nitrite. The yttrium salt is typically present in an amount of at least 0.01 percent by weight, or at least 0.05 percent by weight, or at least 0.2 percent by weight; and at most 3.5 percent by weight, or at most 2.0 percent by weight, or at most 1.0 percent by weight.

The amounts of mineral acid, water, and organic solvent may be the same as those amounts noted above.

Any of the sol-gel compositions above can include a variety of optional ingredients, colorants and/or additives. Optional ingredients include rheology control agents, surfactants, initiators, catalysts, cure-inhibiting agents, reducing agents, acids, bases, preservatives, free radical donors, free radical scavengers and thermal stabilizers, which adjuvant materials are known to those skilled in the art.

The sol-gel compositions may include a colorant, although typically the compositions are colorless and transparent. They are also usually optically clear, having a light transmission of at least 70% or demonstrating a haze value less than 50% depending on gloss level. Haze may be determined according to E430-11 (Standard Test Methods for Measurement of Gloss of High-Gloss Surfaces by Abridged Goniophotometry, 2011).

The sol-gel composition typically has a solids content of 0.1 to 35 percent by weight, often 0.5 to 15 percent by weight, more often 1 to 8 percent by weight, based on the total weight of the curable sol-gel composition.

The adhesion promoting layer (b) typically demonstrates a dry film thickness after curing of at least 100 nm and less than 1000 nm, such as less than 500 nm.

The coated articles of the present invention further comprise (c) a top layer applied to at least one surface of the adhesion promoting layer (b). The top layer (c) may comprise multiple, different coatings serving different purposes, but includes at least an anti-fouling coating. In one example of the present invention, there is no intervening coating applied between the adhesion promoting layer (b) and the anti-fouling coating, such that the anti-fouling coating is directly in contact with and adjacent to the adhesion promoting layer, and the top layer (c) comprises only the anti-fouling coating. Alternatively, there may be other coatings applied between the adhesion promoting layer (b) and the anti-fouling coating as part of the top layer (c), such that the anti-fouling coating is applied on top of the other intervening coatings. Examples of other intervening coatings which may be used to form the top layer (c) include anti-glare coatings, such as AG201, commercially available from PPG, and/or one or more anti-reflective coatings. Glare is understood in the art as a brightness; i. e., bright specular reflection that is perceived by the eye, caused by the reflection of incident light from a substrate surface. Examples of suitable anti-reflective coatings are disclosed in U.S. patent application Ser. No. 15/662,894, incorporated herein by reference in its entirety. There is no additional coating layer applied on top of the anti-fouling coating; it is the outermost coating of the top layer (c) on the coated article. Suitable anti-fouling coating compositions include any of those known in the art. In particular examples of the present invention, the anti-fouling coating comprises a fluorinated silane. Examples of such anti-fouling coatings include EC200 and EC1103B coatings, both commercially available from PPG. Each coating of the top layer (c) may be applied using any of those methods disclosed below.

Each coating composition of the first (adhesion promoting) and the second (top) layers may be applied independently to at least one surface of the substrate by any of the methods described below. In various scenarios, the first coating layer may be applied to one surface of the substrate and the second coating layer applied on top of the first layer; or the first coating layer may be applied to two opposing surfaces of the substrate and the second coating layer applied on top of the first layer on either or both surfaces.

The coated articles described above comprising a multi-layer anti-fouling coating stack having two coating layers may be prepared by a process according to the present invention comprising:

(a) applying a curable film-forming sol-gel composition on at least one surface of a sapphire substrate, to form a coated substrate with a sol-gel adhesion promoting layer, wherein the sol-gel adhesion promoting layer has a dry film thickness of less than 1000 nm after curing;

(b) subjecting the coated substrate to a temperature of at least 500° C. for a time sufficient to effect cure of the sol-gel adhesion promoting layer; and

(c) applying a curable film-forming topcoat composition on at least one surface of the adhesion promoting layer; wherein the topcoat composition comprises an anti-fouling coating, to form a multi-layer, coated article. Step (c) may further comprise applying an anti-glare coating and/or at least one anti-reflective coating between the adhesion promoting layer and the anti-fouling coating. Each of the respective coating layers are as described above.

The compositions that form the coating layers may each be applied to the substrate by one or more of a number of methods such as spray coating, dip coating (immersion), spin coating, slot die coating, or flow coating onto a surface thereof. Spin coating is typically used to apply the sol-gel adhesion promoting layer to the substrate, and spraying is used most often to apply the anti-fouling coating to the sol-gel adhesion promoting layer, such as ultrasonic spray application, precision spray application, and air atomized spray application. The coating compositions may be kept at ambient temperature immediately prior to application. The sol-gel adhesion promoting layer may be applied to a cleaned and untreated or cleaned and treated, e.g., chemically treated or plasma treated, surface of the substrate. After application of the sol-gel adhesion promoting layer, the coated substrate may again be plasma treated prior to application of the coating(s) of the top layer. Again, at least one surface of the substrate is coated; if the substrate has two opposing surfaces, either one or both surfaces may be coated.

After application of the sol-gel adhesion promoting layer, a substantially homogeneous coating layer is formed on the substrate with respect to a cross-section of the sol-gel composition. That is, the concentration of each component is substantially consistent throughout the coating layer. The coated substrate is then subjected to conditions for a time sufficient to effect cure of the sol-gel layer. The term “cure”, “cured” or similar terms, as used in connection with a cured or curable composition, e.g., a “cured composition” of some specific description, means that at least a portion of any polymerizable and/or crosslinkable components that form the curable composition is polymerized and/or crosslinked. Additionally, curing of a composition refers to subjecting said composition to curing conditions such as those listed above, leading to the reaction of the reactive functional groups of the composition. The term “at least partially cured” means subjecting the composition to curing conditions, wherein reaction of at least a portion of the reactive groups of the composition occurs. The compositions can also be subjected to curing conditions such that a substantially complete cure is attained and wherein further curing results in no significant further improvement in physical properties, such as hardness. For example, the coated substrate may be heated to a temperature of at least 500° C. for at least 20 minutes, such as at least 30 minutes (0.5 hours) and up to one hour, to promote the continued solidification of the composition, or the coated substrate may be heated to a temperature of at least 600° C. for at least 20 minutes, such as at least 0.5 hour and up to one hour.

After application of the top layer, the coated substrate is then subjected to conditions for a time sufficient to effect cure of the coating compositions in the top layer, for example, by heating the coated article to a temperature of at least 150° C. for at least 0.5 hour, usually 35 minutes. Alternatively, each coating composition of the top layer may be cured individually before application of the next adjacent coating.

Each of the aspects and characteristics described above, and combinations thereof, may be said to be encompassed by the present invention. For example, the present invention is thus drawn to the following nonlimiting aspects:

1. A coated article comprising:
(a) a substrate comprising sapphire;
(b) an adhesion promoting layer applied to at least one surface of the substrate; wherein the adhesion promoting layer is formed from a curable sol-gel composition and wherein the adhesion promoting layer has a dry film thickness less than 1000 nm after curing; and
(c) a top layer applied to at least one surface of the adhesion promoting layer; wherein the top layer comprises at least an anti-fouling coating.

2. The coated article according to aspect 1, wherein the adhesion promoting layer (b) is formed from a sol-gel composition comprising:

(i) a tetraalkoxysilane;

(ii) a mineral acid;

(iii) water; and

(iv) an organic solvent.

3. The coated article according to aspect 2 wherein the tetraalkoxysilane (i) comprises tetramethoxysilane and/or tetraethoxysilane.

4. The coated article according to any of aspects 2 to 3 wherein the mineral acid (ii) comprises nitric acid or hydrochloric acid.

5. The coated article according to any of aspects 2 to 4, wherein the sol-gel composition further comprises (v) inorganic oxide nanoparticles.

6. The coated article according to aspect 5 wherein the inorganic oxide nanoparticles (v) comprise colloidal silica particles.

7. The coated article according to aspect 1, wherein the adhesion promoting layer (b) is formed from a sol-gel composition comprising:

(i) a zirconium alkoxide;

(ii) an yttrium salt;

(iii) a mineral acid;

(iv) water; and

(v) an organic solvent.

8. The coated article according to aspect 7 wherein the mineral acid (iii) comprises nitric acid or hydrochloric acid.

9. The coated article according to any of aspects 7 to 8 wherein the zirconium alkoxide (i) comprises zirconium (IV) tert-butoxide.

10. The coated article according to any of aspects 7 to 9 wherein the yttrium salt (ii) comprises yttrium acetate.

11. The coated article according to any of aspects 1 to 10, wherein the adhesion promoting layer has a dry film thickness of less than 500 nm after curing.

12. The coated article according to any of aspects 1 to 11, wherein the top layer (c) further comprises an anti-glare coating and/or at least one anti-reflective coating, wherein the anti-glare coating and/or at least one anti-reflective coating is applied between the adhesion promoting layer (b) and the anti-fouling coating.

13. The coated article according to any of aspects 1 to 12, wherein the anti-fouling coating comprises a fluorinated silane.

14. The coated article according to any of aspects 1 to 13, wherein said coated article comprises an ophthalmic element, a screen, a monitor, a security element, a window, a mirror, a watch, and/or active and passive liquid crystal cell element or device.

15. A method of forming a coated article according to any of aspects 1 to 14 comprising:
(a) applying a curable film-forming sol-gel composition on at least one surface of a sapphire substrate, to form a coated substrate with a sol-gel adhesion promoting layer, wherein the sol-gel adhesion promoting layer has a dry film thickness of less than 1000 nm after curing;
(b) subjecting the coated substrate to a temperature of at least 500° C. for a time sufficient to effect cure of the sol-gel adhesion promoting layer; and
(c) applying at least one topcoat composition on at least one surface of the adhesion promoting layer; wherein the topcoat composition comprises an anti-fouling coating, to form a multi-layer, coated article.

16. The method according to aspect 15, wherein the topcoat composition is spray applied to the adhesion promoting layer.

17. The method according to any of aspects 15 or 16, wherein step (c) further comprises applying an anti-glare coating and/or at least one anti-reflective coating between the adhesion promoting layer and the anti-fouling coating.

The following examples are intended to illustrate various aspects of the invention, and should not be construed as limiting the invention in any way. Each of the examples was conducted in triplicate (A, B, and C) and test data reported in the Table. Example 1 is a comparative example, demonstrating a method of forming a coated article with a cure temperature below 500° C. for the curable film-forming sol-gel composition. Examples 4 and 5 are also comparative, demonstrating the preparation of coated substrates without the use of an adhesion promoting layer applied to at least one surface of the substrate prior to application of the anti-fouling coating. Example 4 uses a sapphire substrate while Example 5 uses a soda lime glass substrate. Examples 2 and 3 demonstrate the preparation of coated articles in accordance with the present invention.

### EXAMPLES

### Example 1 (Comparative)

A sapphire substrate was soaked in 12.5 wt % NaOH solution then rinsed with DI water and wiped with IPA (isopropyl alcohol). The cleaned substrate was plasma treated under nitrogen for 15 minutes and then spin coated with a curable film-forming sol-gel composition (Underlayer, 2.4 wt % solids content: SilicAR™ Anti-Reflection LR800 commercially available from Industrial Science & Technology Network, Inc., 1200 Corporate Blvd., STE 10C, Lancaster, Pa. 17601, USA). The coated substrate was cured in an oven at 150° C. for 30 minutes then baked in a Muffle furnace at 400° C. for 30 minutes. The coated substrate was plasma treated for 15 minutes again then coated with an anti-fouling coating (EC1103B, commercially available from PPG), and cured at 150° C. for 35 minutes. The coated substrate was subjected to the Steel Wool Wear Durability Test as described below, which provides an indication of both abrasion resistance and adhesion of a coating to a substrate. The test was conducted after 24 hours on cured samples.

### Example 2

A sapphire substrate was soaked in 12.5 wt % NaOH solution then rinsed with DI water and wiped with IPA. The cleaned substrate was plasma treated under nitrogen for 15 minutes and then spin coated with the Underlayer described in Example 1 above (at a 1.2 wt % solids content). The coated substrate was cured in oven at 150° C. for 30 minutes then baked in a Muffle furnace at 500° C. for 30 minutes. The coated substrate was plasma treated for 15 minutes again then coated with the anti-fouling coating described in Example 1 above, and cured at 150° C. for 35 minutes. The coated substrate was subjected to the Steel Wool Wear Durability Test as described below after 24 hours.

### Example 3

A sapphire substrate was soaked in 12.5 wt % NaOH solution then rinsed with DI water and wiped with IPA. The cleaned substrate was plasma treated under nitrogen for 15 minutes and then spin coated with the Underlayer described in Example 1 above (at a solids content of 2.4 wt %). The coated substrate was cured in an oven at 150° C. for 30 minutes then baked in a Muffle furnace at 600° C. for 30 minutes. The coated substrate was plasma treated for 15 minutes again then coated with the anti-fouling coating described in Example 1 above, and cured at 150° C. for 35 minutes. The coated substrate was subjected to the Steel Wool Wear Durability Test as described below after 24 hours.

### Example 4 (Comparative)

A sapphire substrate was soaked in 12.5 wt % NaOH solution then rinsed with DI water and wiped with IPA. The cleaned substrate was plasma treated under nitrogen for 15 minutes and then coated with the anti-fouling coating described in Example 1 above, and cured at 150° C. for 35 minutes. The coated substrate was subjected to the Steel Wool Wear Durability Test as described below after 24 hours.

### Example 5 (Comparative)

A soda-lime substrate (2″×3″×1.0 mm) was soaked in 12.5 wt % NaOH solution then rinsed with DI water and wiped with IPA. The cleaned substrate was plasma treated under nitrogen for 15 minutes and then coated with the anti-fouling coating described in Example 1 above, and cured at 150° C. for 35 minutes. The coated substrate was subjected to the Steel Wool Wear Durability Test as described below after 24 hours.

The Steel Wool Wear Durability Test is carried out using a 5750 Linear Abraser (available from Taber Industries, Inc., North Tonawanda, N.Y.) with #0000 steel using 1000 g load. The test was conducted at a speed of 60 cycles/min, and an abrasion length of 1″. Due to the fact that the EC coating is so thin (around 10 nm), and due to the harshness of the steel wool abrasion under a 1000 g load, the Steel Wool Wear Durability is an indication of both the abrasion resistance and the adhesion of the coating at the same time.

TABLE
Abrasion (steel wool, 1 Kg load) results

| | | Underlayer | Solids | |
|---|---|---|---|---|
| | | Cure | content of | number |
| | | Temperature | underlayer | of cycle |
| | Substrate | (° C.) | (%) | passed |
| Example 1-A | Sapphire | 400 | 2.4 | Fail at 2000 |
| Example 1-B | Sapphire | 400 | 2.4 | Fail at 2000 |
| Example 1-C | Sapphire | 400 | 2.4 | Fail at 2000 |
| Example 2-A | Sapphire | 500 | 1.2 | Pass 4000 |
| Example 2-B | Sapphire | 500 | 1.2 | Pass 4000 |
| Example 2-C | Sapphire | 500 | 1.2 | Pass 4000 |
| Example 3-A | Sapphire | 600 | 2.4 | Pass 10000 |
| Example 3-B | Sapphire | 600 | 2.4 | Pass 10000 |
| Example 3-C | Sapphire | 600 | 2.4 | Pass 10000 |
| Example 4-A | Sapphire | NA | NA | Fail at 500 |
| Example 4-B | Sapphire | NA | NA | Fail at 500 |
| Example 4-C | Sapphire | NA | NA | Fail at 500 |
| Example 5-A | Soda-lime | NA | NA | Pass 10000 |
| | glass | | | |
| Example 5 -B | Soda-lime | NA | NA | Pass 10000 |
| | glass | | | |
| Example 5-C | Soda-lime- | NA | NA | Pass 10000 |
| | glass | | | |

Water contact angle >100° after abrasion is pass

The steel wear durability of the coated article of Comparative Example 1 is not good as shown in the table above, since it cannot pass 2000 cycles after a 400° C./30 minute cure protocol. The steel wool wear durability of the coated article of Example 2 is better than that of the Comparative Example 1 since it passes 4000 cycles after curing at 500° C. for 30 minutes. The steel wool wear durability of the coated article of Example 3 is better than those of both Examples 1 and 2. The “pass” of steel wool wear durability after 4000 cycles after 500° C. curing in Example 2, and the “pass” of steel wool wear durability after 10,000 cycles after 600° C. curing in Example 3 indicate an improvement of both adhesion and abrasion resistance for these coated articles. The data for Comparative Example 4 demonstrate that there is no Steel Wool Wear Durability of the EC coating over a sapphire substrate without the use of an adhesion promoting layer; every sample failed after only 500 abrasion cycles. All the samples of Comparative Example 5 passed 10,000 cycles Steel Wool Wear Durability testing, illustrating that soda glass substrates do not require the use of an adhesion promoting layer under the anti-fouling coating, unlike sapphire substrates.

Whereas particular embodiments of this invention have been described above for purposes of illustration, it will be evident to those skilled in the art that numerous variations of the details of the present invention may be made without departing from the scope of the invention as defined in the appended claims.

What is claimed is:

1. A coated article comprising:
(a) a substrate comprising sapphire;
(b) an adhesion promoting layer applied to at least one surface of the substrate; wherein the adhesion promoting layer is formed from a curable sol-gel composition and wherein the adhesion promoting layer has a dry film thickness after curing less than 1000 nm; and
(c) a top layer applied to at least one surface of the adhesion promoting layer; wherein the top layer comprises at least an anti-fouling coating.

2. The coated article of claim 1, wherein the adhesion promoting layer (b) is formed from a sol-gel composition comprising:
(i) a tetraalkoxysilane;
(ii) a mineral acid;
(iii) water; and
(iv) an organic solvent.

3. The coated article of claim 2 wherein the tetraalkoxysilane (i) comprises tetramethoxysilane and/or tetraethoxysilane.

4. The coated article of claim 2 wherein the mineral acid (ii) comprises nitric acid or hydrochloric acid.

5. The coated article of claim 2, wherein the sol-gel composition further comprises (v) inorganic oxide nanoparticles.

6. The coated article of claim 5 wherein the inorganic oxide nanoparticles (v) comprise colloidal silica particles.

7. The coated article of claim 1, wherein the adhesion promoting layer (b) is formed from a sol-gel composition comprising:
(i) a zirconium alkoxide;
(ii) an yttrium salt;
(iii) a mineral acid;
(iv) water; and
(v) an organic solvent.

8. The coated article of claim 7 wherein the mineral acid (iii) comprises nitric acid or hydrochloric acid.

9. The coated article of claim 7 wherein the zirconium alkoxide (i) comprises zirconium (IV) tert-butoxide.

10. The coated article of claim 7 wherein the yttrium salt (ii) comprises yttrium acetate.

11. The coated article of claim 1, wherein the adhesion promoting layer (b) has a dry film thickness of less than 500 nm after curing.

12. The coated article of claim 1, wherein the top layer (c) further comprises an anti-glare coating and/or at least one anti-reflective coating, wherein the anti-glare coating and/or at least one anti-reflective coating is applied between the adhesion promoting layer (b) and the anti-fouling coating.

13. The coated article of claim 1, wherein the anti-fouling coating comprises a fluorinated silane.

14. The coated article of claim 1, wherein said coated article comprises an ophthalmic element, a screen, a monitor, a security element, a window, a mirror, a watch, and/or active and passive liquid crystal cell element or device.

15. A method of forming a coated article comprising:
(a) applying a curable film-forming sol-gel composition on at least one surface of a sapphire substrate, to form a coated substrate with a sol-gel adhesion promoting layer, wherein the sol-gel adhesion promoting layer has a dry film thickness of less than 1000 nm after curing;
(b) subjecting the coated substrate to a temperature of at least 500° C. for a time sufficient to effect cure of the sol-gel adhesion promoting layer; and
(c) applying at least one topcoat composition on at least one surface of the adhesion promoting layer; wherein the topcoat composition comprises an anti-fouling coating, to form a multi-layer, coated article.

16. The method of claim 15, wherein the topcoat composition is spray applied to the adhesion promoting layer.

17. The method of claim 15, wherein the adhesion promoting layer is formed from:
(A) a sol-gel composition comprising:
(i) a tetraalkoxysilane;
(ii) a mineral acid;
(iii) water; and
(iv) an organic solvent; or
(B) a sol-gel composition comprising:
(i) a zirconium alkoxide;
(ii) an yttrium salt;
(iii) a mineral acid;
(iv) water; and
(v) an organic solvent.

18. The method of claim 17, wherein the adhesion promoting layer is formed from the sol-gel composition (A), which further comprises inorganic oxide nanoparticles.

19. The method of claim 17, wherein the adhesion promoting layer is formed from the sol-gel composition (B).

20. The method of claim 15, wherein the adhesion promoting layer has a dry film thickness of less than 500 nm after curing.

21. The method of claim 15, wherein the anti-fouling coating comprises a fluorinated silane.

22. The method of claim 15, wherein step (c) further comprises applying an anti-glare coating and/or at least one anti-reflective coating between the adhesion promoting layer and the anti-fouling coating.
